(19) United States
(12) Patent Application Publication
(10) Pub. No.: US 2004/0078577 A1
(43) Pub. Date: Apr. 22, 2004

(54) Method and apparatus for providing xml document encryption

(76) Inventors: Peirong Feng, Singapore (SG); Feng Bao, Singapore (SG); Huijie Robert Deng, Singapore (SG)

Correspondence Address: KNOBBE MARTENS OLSON & BEAR LLP, 2040 MAIN STREET, FOURTEENTH FLOOR, IRVINE, CA, 92614, US

(21) Appl. No.: 10/433,586

(22) PCT Filed: Dec. 4, 2000
(86) PCT No.: PCT/SG00/00196

(51) Int. Cl. H04K 1/00

(52) U.S. Cl. 713/182

(57) ABSTRACT

The invention relates to the field of information security, and more specifically to a mechanism that provides XML with a relative level of security and method of access control on XML documents. The mechanism is applicable to all well-formed XML documents. The secure XML document generated by using this technology keeps the well-formedness of the source document. The invention is directed to providing encryption at the element level of the document.

### FIELD OF THE INVENTION

The invention relates to the field of information security, and more specifically to a mechanism that provides XML with a relative level of security and method of access control on XML documents. The mechanism is applicable to all well-formed XML documents. The secure XML document generated by using this technology keeps the well-formedness of the source document.

### BACKGROUND OF THE INVENTION

XML™, the extensible markup language, is engendering a revolution in online commerce and business communications. For the first time, an accessible standard is available that enables real business applications across the Internet.

XML

At the same time, the widespread adoption of information security technology is providing the foundation for global electronic security within business applications. A fusion of these technologies is inevitable, enabling secure interactions among businesses and consumers across the Internet.

XML

XML, which can either be regarded as a significant extension of HTML (hypertext markup language) or, more properly, as a simplification of SGML (standard generalized markup language), is a meta-language for defining the structure of documents. That is to say, using XML, you can unambiguously define the structure of a document containing, for example, a purchase order. If multiple entities agree on the structure of such a document then they can meaningfully communicate those documents between each other electronically, and automatically.

As the adoption of XML spreads across platforms, clients and servers, it is poised to become the language of business across the Internet.

XML Standards

Overall, XML technology is being guided and defined by the W3C™ (World Wide Web Consortium). Under this body, various groups are working towards defining standards for XML itself, as well as various complementary technologies such as XSL™ (XML style language for automatically converting from XML to HTML), etc.

The goal of this arm of the W3C is to lay down standards that define how XML can be used across broad, horizontal markets. In parallel with the work of the W3C, various industry groups are additionally defining standards that govern the use of XML within their particular vertical markets.

Document Definitions

The definition of the structure of a particular type of document is called a DTD (document type definition). Across the planet, industry consortiums are coming together to define DTDs for various vertical markets; such as healthcare, insurance, etc. Once these standards are in place, electronic communication within and among these industries will be, for the first time, uniformly possible across the Internet in a completely standard manner.

Electronic Security

Adoption of electronic techniques for doing business across the Internet requires the same (or better) security guarantees as the real world: Sensitive information should not be publicly accessible (security envelopes). Documents should identify who they are from (signatures). Documents should be unalterable (no whiteout). And finally, possession of a document should be proof that it was actually sent (again, signatures).

Aspects of Electronic Security

The adoption of appropriate cryptographic technologies enables these four critical aspects of electronic security, collectively referred to as PAIN:

Privacy—using encryption techniques, it is possible to transform the contents of an electronic document so that it is unintelligible to anyone but the intended recipient. This means that sensitive documents can be safely transmitted across open networks, without the possibility of them being intercepted and read by an unauthorized individual.

Authentication—using certificates and digital signatures, in tandem with a trusted third party infrastructure, it is possible to uniquely identify the origin of an electronic document. This means that a recipient can verify, with absolute certainty, from whom a particular message has arrived.

Integrity—a second benefit of digital signatures is that they can be used to verify that an electronic document has arrived intact and unaltered from the moment that the sender signed it. This means that a recipient can verify that a document has not been altered, whether deliberately or accidentally, from the time that it was issued.

Non-repudiation—with a public key infrastructure in place, it is not possible for the signer of an electronic document to subsequently disavow the signature. This means that a document cannot be denied at a later date in an attempt, for example, to revoke an order because of changing market conditions or malicious intent.

Cryptography

Cryptography is the study of mathematical techniques related to aspects of information security such as confidentiality, data integrity, entity authentication, and data origin authentication. Cryptography is not the only means of providing information security, but rather one set of techniques.

These techniques include symmetric key crypto-systems (DES, RC4, IDEA, etc.) and public key crypto-systems (RSA, ECC, DSA, etc.). Symmetric key crypto-systems are mainly used for data encryption. Public key crypto-systems can also be used for data privacy protection, furthermore; when combined with message digest functions in cryptography (MD5, SHA-1, etc.), they can be used to generate digital signatures for authentication and integrity protection at the same time.

XML Security (Prior Arts)

It is now generally accepted that XML is the meta-language through which the content and structure of information on the Internet will be defined. XML will also become the main mechanism for interoperability among applications. However, in the networked world, sensitive information becomes more generally available and accessible. This increase in information flow introduces a number of risks, necessitating the introduction of security solutions, which can provide both authentication of the parties involved in any transaction, and protect data while in transit or storage.

XML Signature

There is a joint Working Group of the IETF (Internet Engineering Task Force) and W3C, called XML-Signature WG. The mission of this working group is to develop an XML compliant syntax used for creating and representing the signature of Web resources and portions of protocol messages (anything referencable by a URI) and procedures for computing and verifying such signatures.

XML Signatures provide integrity, message authentication, and/or signer authentication services for data of any type, whether located within the XML that includes the signature or elsewhere. XML Signatures can be applied to any digital content (data object), including XML. An XML Signature may be applied to the content of one or more resources. Enveloped or enveloping signatures are over data within the same XML document as the signature; detached signatures are over data external to the signature document.

SDML—Signed Document Markup Language

The Signed Document Markup Language (SDML) was developed by the Financial Services Technology Consortium (FSTC) as part of the Electronic Check Project. SDML is designed to:

tag the individual text items making up a document,

group the text items into document parts which can have business meaning and can be signed individually or together,

allow document parts to be added and deleted without invalidating previous signatures, and

allow signing, co-signing, endorsing, co-endorsing, and witnessing operations on documents and document parts.

The signatures become part of the SDML document and can be verified by subsequent recipients as the document travels through the business process. But SDML does not define encryption.

While cryptography has long been accepted by the public and private sectors as the method by which to enable applications to securely work over public networks, the underlying technologies of digital signatures and encryption are not immediately usable within an XML framework due to the lack of XML supports for these technologies.

There exists a need to provide new ways to apply cryptographic technologies to XML framework. It is desirable to provide full encryption and digital signature capabilities, which can be used in an Intranet, Extranet or Internet environment.

It is an object of the present invention to seek to address at least one problem or need associated with the prior art.

### SUMMARY OF THE INVENTION

In this regard, the present invention provides a method and/or system of providing XML document security by way of encryption, the encryption being in accordance with any symmetric key cryptosystem, the document having contents defined by a plurality of levels, namely at least an entity level, the entity level having at least one element level including element(s), the method and/or system providing the encryption at the element level.

Various other aspects and features of the present invention are set out in the attached claims.

In essence, the present invention stems from the realisation that most of the effects on XML security are focused on digital signature and verification. The main reason that security is related to the transport level. Thus the privacy of the XML documents depends on the security of the document transportation. In'the present invention, however, an element-level security mechanism is provided for XML documents, and in this way, the privacy of secured documents doesn't rely directly on secure document transportation.

In the prior art, protection of an XML document is provided by encrypting the document as a whole. As a result, the encrypted document isn't XML-formatted and human readable any more. However, it is not possible to leave some contents of the document unencrypted if using the prior art methods to protect the document.

The present invention addresses these problems by providing a concept of more secure XML document, which has the following features:

Element-wise Encryption—This means that the encryption is held at the element level. What's more, in accordance with the present invention, a user may selectively encrypt elements or encrypt elements in accordance with a predetermined schema, with or without leaving other elements unchanged, and/or encrypt an element(s) with its children (sub-elements) as one block, again selectively or in accordance with a predetermined schema.

In addition, it is preferable to provide at least one of the following features in addition to the element-wise encryption above, namely:

Various Encryption Algorithms and Modes Supporting—All kinds of symmetric key encryption algorithms, either block cipher or stream cipher, can be used in this security mechanism for XML. And different encryption modes (CBC, EBC, etc.) can be applied here as well. DES, Triple-DES and IDEA are all examples of commonly used symmetric key ciphers.

Convenient Key Management—Each element can be encrypted using one unique key value. The key value of each element is secured by the document key or the key value of its parent element. The whole document is protected by the document key.

XML Compatibility—All secure XML documents converted from well-formed XML document are still well-formed. No new element definitions are added into the secure format. We only introduce several new attributes and one namespace for secure XML document definition, which are shown in the following table.

Advantageously, the present invention does not require a new element definition for secure XML document. The namespace and attributes currently used in secure document are shown in the following table (more attributes can be added when needed in future versions):

| Type | Name | Description |
|---|---|---|
| namespace | xmlns:sxml | namespace for secure XML document |
| | | attributes |
| attribute | sxml:secured | whether the document is in secure |
| (root only) | | format or not |
| | sxml:algoritim | encryption algorithm and mode used |
| | sxml:keyprotection | key management method |
| attribute | sxml:encrypted | whether the element is encrypted or not |
| (general) | sxml:keyinfo | information about the key value used to |
| | | encrypt the element and key values of |
| | | children elements |

Secure XML document can be applied to various Internet applications. In an on-line information service, secure XML technology can protect the valuable information to be provided. In a cyber-library, books and magazines can be provided as secure XML documents, readers can view TOC and other introductory parts, but need to pay money or give more information if they want to read the whole content of the book. In an electronic transaction, sensitive information can be stored in encrypted elements in secure XML documents.

### DETAILED DESCRIPTION OF THE PRESENT INVENTION

Preferred embodiments of the present invention will now be described with reference to the accompanying drawings, in which:

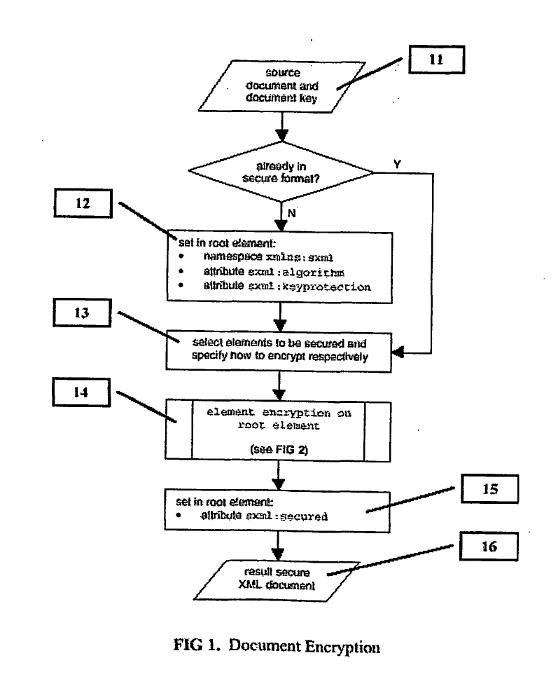

FIG. 1 illustrates schematically document encryption in accordance with the present invention,

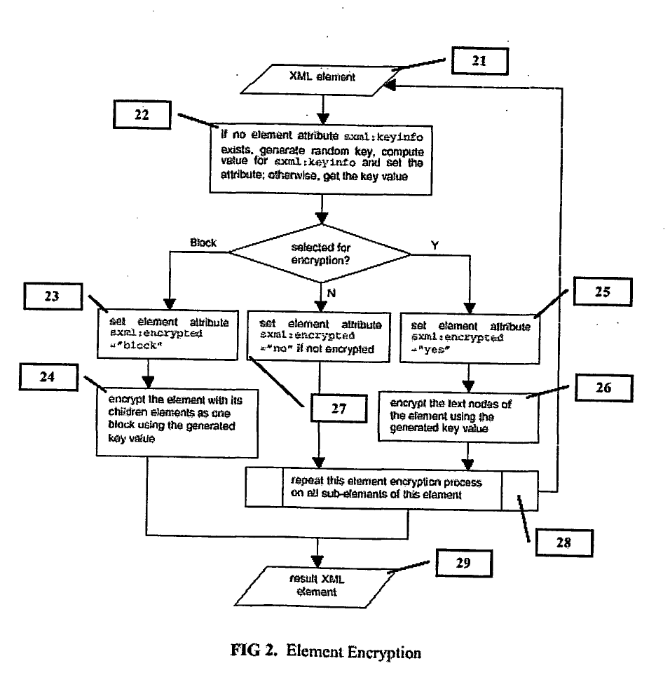

FIG. 2 illustrates schematically element encryption in accordance with the present invention,

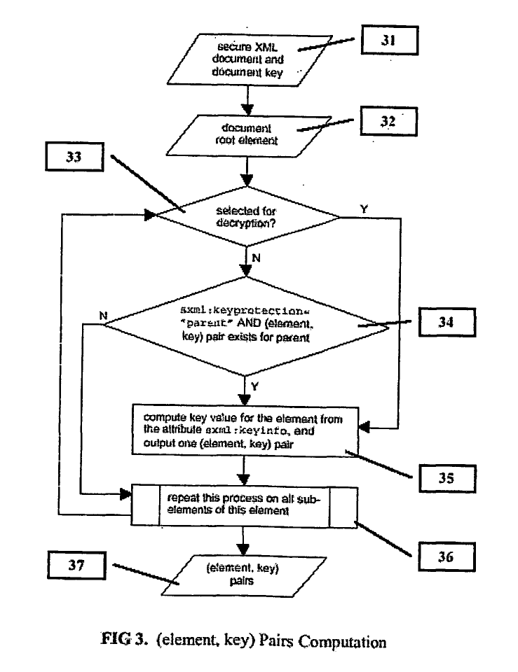

FIG. 3 illustrates schematically element and key pair computation in accordance with the present invention,

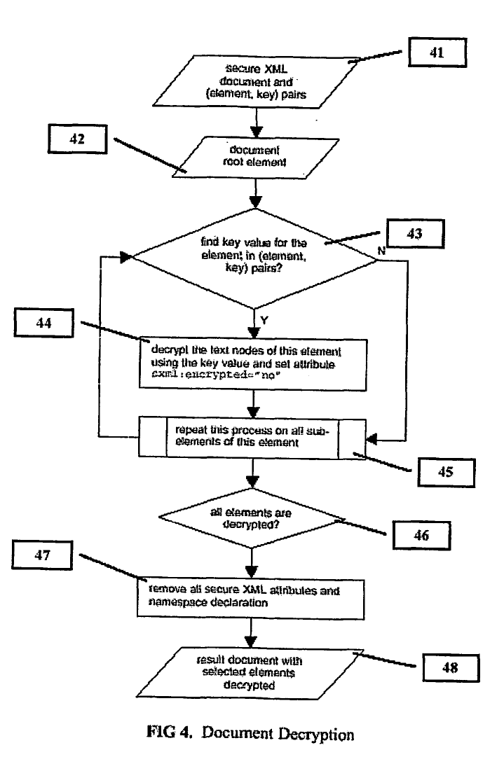

FIG. 4 illustrates schematically document decryption in accordance with the present invention, and

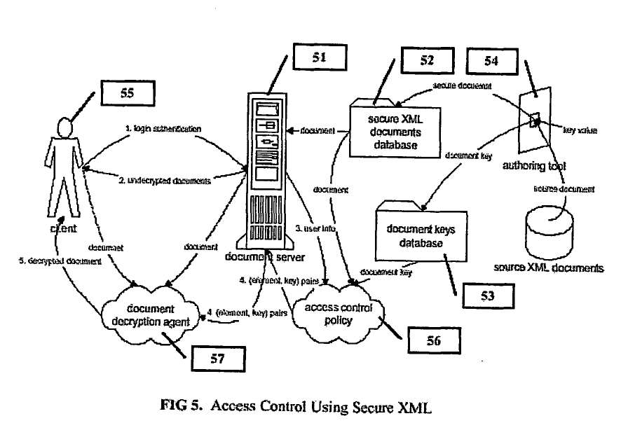

FIG. 5 illustrates schematically one exemplary implementation of the present invention.

### XML INTRODUCTION

XML is based on the concept of documents composed of a series of entities. Each entity can contain one or more logical elements. Each of these elements can have certain attributes (properties) that describe the way in which it is to be processed. XML provides a formal syntax for describing the relationships between the entities, elements and attributes that make up an XML document, which can be used to tell the computer how it can recognize the component parts of each document.

XML differs from other markup languages in that it does not simply indicate where a change of appearance occurs, or where a new element starts. XML sets out to clearly identify the boundaries of every part of a document, whether it is a new chapter, a piece of boilerplate text, or a reference to another publication. To allow the computer to check the structure of a document users must provide it with a document type definition that declares each of the permitted entities, elements and attributes, and the relationships between them.

Elements are the most common form of markup. Delimited by angle brackets, most elements identify the nature of the content they surround. Some elements may be empty, as seen above, in which case they have no content. If an element is not empty, it begins with a start-tag, <element>, and ends with an end-tag, </element>.

Attributes are name-value pairs that occur inside tags after the element name. For example, <div class=“preface”>is the div element with the attribute class having the value preface. In XML, all attribute values must be quoted.

Secure XML Document Structure

Element-Wise Encryption for XML Document

The main idea of this invention is element-wise encryption for XML document, i.e. the encryption is held at element-level and only sensitive elements are encrypted while the others are left untouched. For example, there is one XML document describing staff information of the company:

[image]

Generally some sensitive information, such as salary, can only be available to senior members of the company. So this kind of information should be protected in storage. While some other information in this document should still be available publicly, such as designation, department, etc. All these requirements can be easily satisfied by using XML element-wise encryption technology.

The secure XML document can be in the following format:

[image]

In the above example, all the salary elements are secured. And the email of “Big Boss” is secured too while that of “Worker”s are kept in clear text. Only the content of the selected elements is encrypted. The children of the encrypted element will be left in clear text if not selected.

NOTE: The attribute sxml:encrypted indicates whether the context of the current element is encrypted or not. If “yes”, the content is encrypted; if “no”, the content is unencrypted.

NOTE: The attribute sxml:secured indicates whether the document has any encrypted element or not.

Element Block Encryption

Element can be encrypted with its children (sub-elements) as one block. Sometimes, it may be unnecessary to encrypt XML document element by element. This situation can be avoided by using elements group encryption.

An Internet publisher, for instance, usually only publishes the title, author, and abstract of the book over Internet. The reader can read the whole content only after paying for the book.

[image]

In this case, it is repetitive and unnecessary to encrypt all the content elements one by one. So we can encrypt the content element with its children as one block. Here's the result:

[image]

NOTE: If the value of sxml:encrypted is “block”, then the content of the element is encrypted with its children as one block.

Encryption Algorithms, and Keys

Encryption Algorithm and Mode

All kinds of symmetric key encryption algorithms, either block cipher or stream cipher, can be used in this security mechanism for XML. And different encryption modes (CBC, EBC, etc.) can be applied here as well. DES, Triple-DES and IDEA are all examples of commonly used symmetric key ciphers. The root element has one attribute called sxml:algorithm specifying the encryption algorithm and encryption mode used in the secure XML format.

For example, as shown in the secure XML document given in the above section:

[image]

The attribute sxml:algorithm here specifies IDEA encryption algorithm and CBC encryption mode for the document.

NOTE: The value of the attribute sxml:algorithm usually is in the format ALGNAME/MODE, where ALGNAME is the encryption algorithm name and MODE is t he encryption mod e used in the document.

Key Management

One special feature of this technology is that we can use different key values to encrypt different element in the XML document. Different key values are generated randomly for different elements when the XML document is being encrypted.

The point here is how to manage all the key values used so that we are able to fetch them when decrypting selected elements of the document. The answer is the root key, which is the secret value used to protect all the key values for element encryption.

One way to protect key values is to encrypt them using the document key respectively. The encrypted key values are saved in the attribute sxml:keyinfo of the corresponding element. And the document root element will have an attribute called sxml:keyprotection with value “root” indicating that the key values are encrypted using the document key.

Another method to protect key values is based on the hierarchical feature of XML document. In XML document, every element node except the root element has a parent element node:

“. . . , for each non-root element C in the document, there is one other element P in the document such that C is in the content of P, but is not in the content of any other element that is in the content of P. P is referred to as the parent of C, and C as a child of P.”

---XML 1.0 (W3C Recommendation Feb. 10, 1998)

Like the former method, the key value of some non-root element will be encrypted, not using the document key but using the key value of its parent element. The key value of root element will be encrypted using the document key. All elements will have an attribute sxml:keyinfo with the encrypted key value as the attribute value, and the attribute value of the root element attribute sxml:keyprotection will be “parent”.

Both methods has the following features:

the key value of every element is randomly generated and is unique;

only one key, i.e. the document key, is required to be remembered or saved for secure XML document.

NOTE: The value of attribute sxml:keyinfo stores the encrypted key value for current element.

NOTE: The attribute sxml:keyprotection indicates which method the document uses to manage the key values for all elements.

XML Compatibility

All secure XML documents converted from well-formed XML document are still well-formed. No new element definitions are added into the secure format. We only introduce several new attributes into the document. The attributes are

root element only attributes

| | | |
|---|---|---|
| sxml:secured | (yes\|no) | REQUIRED |
| sxml:algorithm | CDATA | REQUIRED |
| sxml:keyprotection | (root\|parent) | “parent” |

general element attributes

| | | |
|---|---|---|
| sxml:encrypted | (yes\|no\|block) | REQUIRED |
| sxml:keyinfo | CDATA | REQUIRED |

All the new attributes are placed in the namespace sxml, which is identified by URL

http://www.krdl.org.sg/sxml/

As shown in the above examples, the namespace declaration is placed before wherever secure XML attributes are needed:

xmlns:sxml=“http://www.krdl.org.sg/sxml”

Secure XML Document Operations

Now we give the procedures to author secure XML documents and decrypt them.

Document Encryption

The document encryption process is illustrated in FIG. 1. When authoring a secure XML document, two inputs are needed: source document and document key (11).

The source document can be already in secure XML format. In this case, the document key should be equal to the corresponding value, the existing namespace declaration with attributes of document root element—sxml:algorithm and sxml:keyprotection—will be kept unchanged.

If the source document is not in secure XML format, then namespace declaration

xmlns:sxml=“http://www.krdl.org.sg/sxml”

shall be added into the attribute list of the root element. And encryption algorithm and mode, key management method is specified for the encryption process, and is given as the values of attributes sxml:algorithm and sxml:keyprotection of the root element respectively. (12)

The next step (13) is to decide which elements are sensitive and the way to secure them (as one block with children elements or individually). Then the element encryption process is applied on the document root element (14) and will be applied on all elements recursively. After the element encryption process, the attribute of root element sxml:secured should be set to “yes” (15). And finally we get the result document in secure XML format (16).

Element Encryption Process

The element encryption process (FIG. 2) starts from the document root element and then is applied on all elements recursively (14).

When the element encryption process is applied on an element (21), the attribute sxml:keyinfo should be checked first (22). If the attribute is already set, then the key value for this element can be computed from the attribute value. Otherwise, a random key value is generated for the element and the attribute value of sxml:keyinfo is set to the encryption result of this new generated key value using the document key value or the key value of the parent element.

Based on the element selection (13), the element is processed in different ways. If the element is to be encrypted as one block with its children, then the attribute sxml:encrypted is set to “block” (23), the whole element with all its children will be encrypted as one entity using the key value for this element (24), and the ciphertext is given in the result element (29). The encryption process for the element ends.

If the element is selected to be encrypted individually, then the attribute sxml:encrypted is set to “yes” (25), all the text nodes (content) of this element are encrypted using the key value for this element (26). If the element is not selected and is unencrypted in the source document, the attribute sxml:encrypted is set to “no” (27) and the content is left unchanged. Then the element encryption process is applied on all the children elements (28). After all sub-elements are processed, the result for this element encryption is given (29). The encryption process for the element ends.

Document Decryption

If user wants to view contents of some encrypted elements in a secure XML document, these elements can be decrypted first while other elements are left untouched. The decryption process includes two steps: (element, key) pairs computation (FIG. 3) and document decryption (FIG. 4).

(element, key) Pairs Computation

Before a secure XML document is decrypted, some (element, key) pairs need to be computed based on user's element selection and access right. Surely this computation needs source secure XML document and the corresponding document key (31). This process is usually held on server side. Like the document encryption process, this process starts from the document root element (32). If the element is selected for decryption (33) and user has access right to it, or sxml:keyprotection equals “parent” and there is already one (element, key) pair for the parent element (34), then the key value for this element will be decrypted and one (element, key) pair will be output (35). For all sub-elements, repeat this process (36).

After this process is finished, a set of (element, key) pairs are generated for document decryption (37).

Document Decryption

After (element, key) pairs are prepared, the source secure XML document is ready for decryption (41).

Again, the document decryption process starts from the document root element (42). For each element, if the corresponding key value can be found in the (element, key) pairs (43), the content of this element will be decrypted using the key value and the attribute sxml:encrypted is set to “no” (44). For all sub-elements, repeat this process (45).

After above procedure is finished, we need to check whether all elements are decrypted or not (46). If so, all secure XML attributes and namespace declaration should be removed (47). A new XML document is generated with selected element decrypted (48) after the document decryption process is finished.

Access Control Using Secure XML

In this section, a sample usage of secure XML document is given. Please note this sample is just guidance for secure XML document usage Secure XML documents surely can be used in other ways not described in this section as long as the security of the documents is guaranteed.

Usually one document server (51) stores all secure XML documents in secure XML document database (52) and all document keys in document keys database (53). These documents and keys are prepared by a secure XML authoring tool (54) with input from source XML document and document key value.

In most common cases, client (55) logs on first and browses the undecrypted secure XML document over network or some terminal. If client is interested in the contents of some encrypted elements, client will send element selection and other information (some payment data usually) to the server.

The server will verify the user information first and check whether user has the access right to the elements user selected based on the access control policy (56). If all checks are passed, the server will decrypt the key values for the elements user selects and output some (element, key) pairs. Then a document decryption agent (57) will decrypt the document for the client using these (element, key) pairs. The document decryption agent can be either client-side or server-side.

Then the client can read the contents of his/her choice if client has the access right.

Copyright Protection

As the selected sensitive information is provided in ciphertext and only authorized users can access this kind of information in secure XML document, this technology also suggests a new method for copyright protection. If the publishers adopt this mechanism for their electronic publications, then other parties cannot provide key information for accessing the secured data in the document. This means that publishers can utilize this mechanism to protect their electronic publications.

1. A method of providing XML document security by way of encryption, the encryption being in accordance with any symmetric key cryptosystem, the document having contents defined by a plurality of levels, namely at least an entity level, the entity level having at least one element level including element(s), the method including the step of:
providing the encryption at the element level.

2. A method as claimed in claim 1, including the further step of:
providing the encryption to selected element(s).

3. A method as claimed in claim 1, including the further step of:
providing the encryption in accordance with a predetermined schema to element(s).

4. A method as claimed in claim 1, 2 or 3, in which an element is encrypted with its children elements as one block.

5. A method as claimed in any one of claims 1, wherein each element is encrypted using a key value.

6. A method as claimed in claim 5, wherein the key value is a random key value.

7. A method as claimed in claim 5, wherein the key value is encrypted using the value of its parent element.

8. A method as claimed in claim 7, wherein the key value of a root element is also protected by a document key.

9. A method as claimed in claim 5, wherein the key value is encrypted using a document key.

10. A method as claimed in claim 1, wherein an indication is given whether there are any elements with encrypted contents in the document.

11. A method as claimed in claim 1, wherein an indication is given of the encryption algorithm and encryption mode used in the securing the XML document.

12. A method as claimed in claim 1, wherein an indication is given of the key management method used in the secure XML document.

13. A method as claimed in claim 1, wherein an indication is given of whether the content of an element is encrypted, encrypted with its children as one block, or is unchanged.

14. A method as claimed in claim 10, in which the indication is provided by way of a namespace declaration to specify field(s) of attributes used in the document.

15. A method as claimed in claim 1, wherein information about the key values for elements is stored.

16. A method as claimed in claim 1, wherein the well-formedness of the source document is substantially kept in tact.

17. A method of protecting copyright of electronic documents using a method as claimed in claim 1.

18. A system adapted to provide XML document security by way of encryption, the document having contents defined by a plurality of levels, namely at least an entity level, the entity level having at least one element level including element(s), the system including:
encryption means adapted to provide encryption with any symmetric key cryptosystem, and wherein the encryption means provides encryption at the element level.

19. A system as claimed in claim 18, wherein the encryption means provides encryption to selected element(s).

20. A system as claimed in claim 18, wherein the encryption means provides encryption in accordance with a predetermined schema to element(s).

21. A method as claimed in claim 18, 19 or 20, in which the encryption means encrypts an element is encrypted with its children elements as one block.

22. A system as claimed in claim 18, wherein the encryption means encrypts each element using a key value.

23. A system as claimed in claim 22, wherein the key value is a random key value.

24. A system as claimed in claim 22, wherein the key value is encrypted using the value of its parent element.

25. A system as claimed in claim 24, wherein the key value of a root element is also protected by a document key.

26. A system as claimed in claim 22, wherein the key value is encrypted using a document key.

27. A system as claimed in claim 18, further including indicator means for indicating whether there are any elements with encrypted contents in the document.

28. A system as claimed in claim 18, wherein the indicator means provides an indication of the encryption algorithm and encryption mode used in the securing the XML document.

29. A system as claimed in claim 18, wherein the indicator means provides an indication of the key management method used in the secure XML document.

30. A system as claimed in claim 18, wherein the indicator means provides an indication of whether the content of an element is encrypted, encrypted with its children as one block, or is unchanged.

31. A system as claimed in claim 18, further including storage means for storing information about the key values of elements.

32. A system adapted to use a method as claimed in claim 1 to secure XML documents.

33. A system as claimed in claim 18, further including access control means providing control of access to the document.

34. An XML document encrypted in accordance with the method as claimed in any one of claims 1 to 17.

35. An XML document encrypted in accordance with the system as claimed in claim 18.

36. A computer program product including:
a computer usable medium having computer readable program code and computer readable system code embodied on said medium for providing XML document security by way of encryption, within a data processing system, the encryption being in accordance with any symmetric key cryptosystem, the document having contents defined by a plurality of levels, namely at least an entity level, the entity level having at least one element level including element(s), said computer program product further including:
computer readable code within said computer usable medium for providing the encryption at the element level.

37. A computer program product as claimed in claim 36, wherein the computer readable code is further adapted to perform the method as claimed in claim 2.
